(19) United States
(12) Patent Application Publication
(10) Pub. No.: US 2023/0007123 A1
(43) Pub. Date: Jan. 5, 2023

(54) METHOD AND APPARATUS FOR AUTOMATED QUALITY MANAGEMENT OF COMMUNICATION RECORDS

(71) Applicant: Talkdesk, Inc., San Francisco, CA (US)

(72) Inventors: Kathy Krucek, N. Barrington, IL (US); Filipe Plácido, Penela (PT); Nuno Eufrasio, Coimbra (PT); Rui Palma, Figueira-da-Foz (PT); Joao Salgado, Coimbra (PT); Ben Rigby, San Francisco, CA (US); Pedro Andrade, Coimbra (PT); Jason Fama, San Carlos, CA (US)

(21) Appl. No.: 17/366,883

(22) Filed: Jul. 2, 2021

(51) Int. Cl. H04M 3/51; G06N 20/00; G10L 15/22

(52) U.S. Cl. CPC H04M 3/5175; G06N 20/00; G10L 15/22

(57) ABSTRACT

Disclosed implementations use automated transcription and intent detection and an AI model to evaluate interactions between an agent and a customer within a call center environment. The evaluation flow used for manual evaluations is leveraged so that the evaluators can correct the AI evaluations when appropriate. Based on such corrections, the AI model can be retrained to accommodate specifics of the business and center—resulting in more confidence in the AI model over time.

### BACKGROUND

Contact centers, also referred to as “call centers”, in which agents are assigned to queues based on skills and customer requirements are well known. FIG. 1 is an example system architecture 100, of a cloud-based contact center infrastructure solution. Customers 110 interact with a contact center 150 using voice, email, text, and web interfaces to communicate with the agents 120 through a network 130 and one or more of text or multimedia channels. The platform that controls the operation of the contact center 150 including the routing and handling of communications between customers 110 and agents 120 for the contact center 150 is referred herein as the contact routing system 153. The contact routing system 153 could be any of a contact center as a service (CCaS) system, an automated call distributor (ACD) system, or a case system, for example.

The agents 120 may be remote from the contact center 150 and handle communications (also referred to as “interactions” herein) with customers 110 on behalf of an enterprise. The agents 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network (LAN). The network types are provided by way of example and are not intended to limit types of networks used for communications.

The agents 120 may be assigned to one or more queues representing call categories and/or agent skill levels. The agents 120 assigned to a queue may handle communications that are placed in the queue by the contact routing system 153. For example, there may be queues associated with a language (e.g., English or Chinese), topic (e.g., technical support or billing), or a particular country of origin. When a communication is received by the contact routing system 153, the communication may be placed in a relevant queue, and one of the agents 120 associated with the relevant queue may handle the communication.

The agents 120 of a contact center 150 may be further organized into one or more teams. Depending on the embodiment, the agents 120 may be organized into teams based on a variety of factors including, but not limited to, skills, location, experience, assigned queues, associated or assigned customers 110, and shift. Other factors may be used to assign agents 120 to teams.

Entities that employ workers such as agents 120 typically use a Quality Management (QM) system to ensure that the agents 120 are providing customers 110 with a high-quality product or service. QM systems do this by determining when and how to evaluate, train, and coach each agent 120 based on seniority, team membership, or associated skills as well as quality of performance while handling customer 110 interactions. QM systems may further generate and provide surveys or questionnaires to customers 110 to ensure that they are satisfied with the service being provided by the contact center 150.

Historically, QM forms are built by adding multiple choice questions where different choices are worth different point values. The forms are then filled out manually by evaluators based on real time or recorded monitoring of agent interactions with customers. For example, a form for evaluating support interactions might start with a question where the quality of the greeting is evaluated. A good greeting where the agent introduced themselves and inquired about the problem might be worth 10 points and a poor greeting might be worth 0, with mediocre greetings being somewhere in between on the 1-10 scale. There might be 3 more questions about problem solving, displaying empathy, and closing. Forms can also be associated with one or more queues (also sometimes known as “ring groups”). As noted above, a queue can represent a type of work that the support center does and/or agent skills. For example, a call center might have a tier 1 voice support queue, a tier 2 voice support queue, an inbound sales queue, an outbound sales queue, and a webchat support queue. With traditional quality management based on multiple choice question forms filled outs by evaluators, it is time prohibitive to evaluate every interaction for quality and compliance. Instead, techniques like sampling are used where a small percent of each agent's interactions are monitored by and evaluator each month. This results in a less than optimum quality management process because samples are, of course, not always fully representative of an entire data set.

### SUMMARY

Disclosed implementations leverage known methods of speech recognition and intent analysis to make corrections to inputs to be fed into an Artificial Intelligence (AI) model to be used for quality management scoring of communications. An AI model can be used to detect the intent of utterances that are passed to it. The AI model can be trained based on “example utterances” and then compare the passed utterances, from agent/customer interactions to the training data to determine intent with a specified level (e.g., expressed as a score) of confidence. Intent determinations with a low confidence score can be directed to a human for further review. A first aspect of the invention is a method for assessing communications between a user and an agent in a call center, the method comprising: extracting text from a plurality of communications between a call center user and a call center agent to thereby create a communication record; for each of the plurality of communications: assessing the corresponding text of a communication record by applying an AI assessment model to obtain an intent assessment of one or more aspects of the communication, wherein the AI assessment model is developed by processing a set of initial training data and supplemental training data, wherein the supplemental training data is based on reviewing manual corrections to previous assessments by the assessment model.

### BRIEF DESCRIPTION OF THE DRAWING

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 is a schematic representation of a call center architecture.

FIG. 2 is a schematic representation of a computer system for quality management in accordance with disclosed implementations.

FIG. 3 is an example of a QM form creation user interface in accordance with disclosed implementations.

FIG. 4 is an example of a user interface showing choices detected in interactions based on the questions in an evaluation form in accordance with disclosed implementations.

FIG. 5 is an example of evaluations page user interface in accordance with disclosed implementations.

FIG. 6 is an example of an agreements review page user interface in accordance with disclosed implementations.

FIG. 7 is a flowchart of a method for quality management of agent interactions in accordance with disclosed implementations.

### DETAILED DESCRIPTION

Certain terminology is used in the following description for convenience only and is not limiting. Unless specifically set forth herein, the terms “a,” “an” and “the” are not limited to one element but instead should be read as meaning “at least one.” The terminology includes the words noted above, derivatives thereof and words of similar import.

Disclosed implementations overcome the above-identified disadvantages of the prior art by adapting contact center QM analysis to artificial intelligence systems. Disclosed implementations can leverage known methods of speech recognition and intent analysis to make corrections to inputs to be fed into an Artificial Intelligence (AI) model to be used for quality management scoring of communications. Matches with a low confidence score can be directed to a human for further review. Evaluation forms that are similar to forms used in conventional manual systems can be used. Retraining of the AI model is accomplished through individual corrections in an ongoing manner, as described below, as opposed to providing a new set of training data.

Disclosed implementations use automated transcription and intent detection and an AI model to evaluate every interaction, i.e. communication, (or alternatively a large percentage of interactions) between an agent and a customer. Disclosed implementations can leverage the evaluation flow used for manual evaluations so that the evaluators can correct the AI evaluations when appropriate. Based on such corrections, the AI model can be retrained to accommodate specifics of the business and center—resulting in more confidence in the AI model over time.

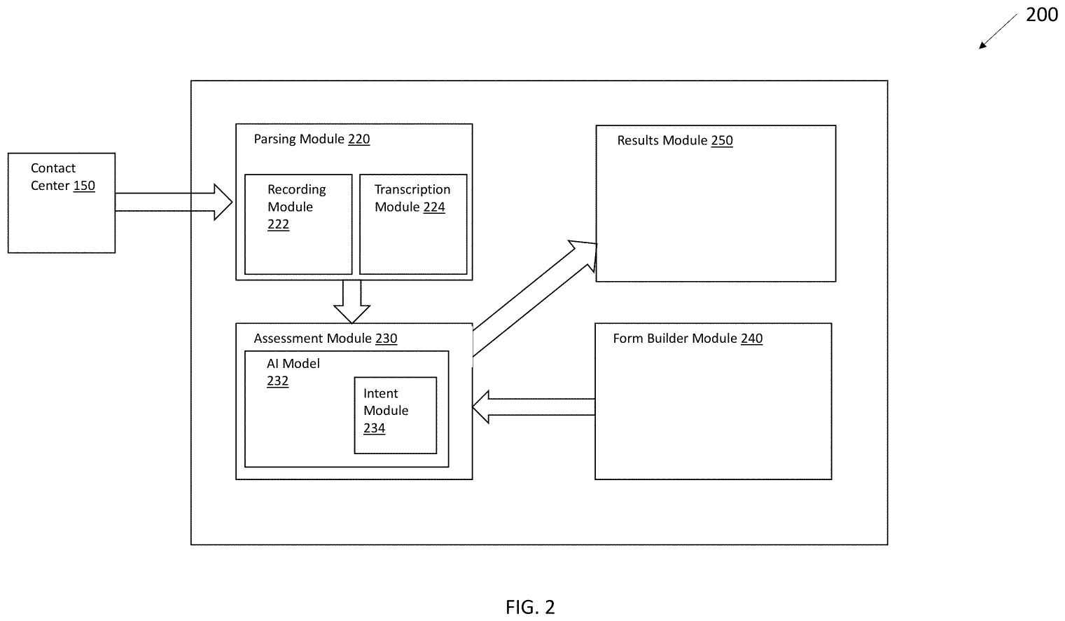

FIG. 2 illustrates a computer system for quality management in accordance with disclosed implementations. System 200 in includes parsing module 220 (including recording module 222 and transcription module 224) which parses words and phrases from communications/interactions for processing in the manner descried in detail below. Assessment module 232 includes Artificial Intelligence (AI) model 232, which includes intent module 234 that determines intent of and scores interactions in the manner described below. Intent module 234 can leverages any one of many known intent engines to analyze transcriptions of transcription module 224. Form builder module 240 includes user interfaces and processing elements for building AI enabled evaluation forms as described below. Results module 250 includes user interfaces and processing elements for presenting scoring results of interactions individually and in aggregate form. The interaction of these modules will become apparent based on the description below. The modules can be implemented through computer-executable code stored on non-transient media and executed by hardware processors to accomplish the disclosed functions which are described in detail below.

As noted above, conventional QM forms are built by adding multiple choice questions where different choices are worth different point values. For example, a form for evaluating support interactions might start with a question where the quality of the greeting is evaluated. A good greeting where the agent introduced themselves and inquired about the problem might be worth 10 points and a poor greeting might be worth 0. There might be additional questions in the form relating to problem solving, displaying empathy, and closing. As noted above, forms can also be associated with one or more queues

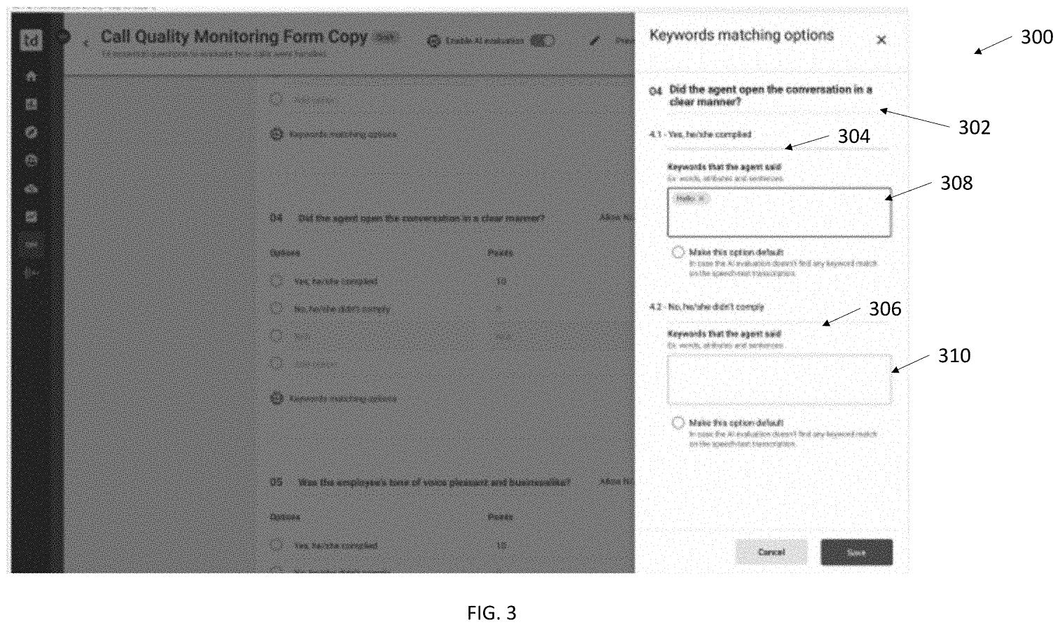

FIG. 3 illustrates a user interface 300 of a computer-implemented form generation tool, such as form builder module 240 (FIG. 2) in accordance with disclosed implementations. User interface 300 can be used to enable forms for AI evaluation. A user can navigate the UI to select a question at drop down menu 302 for example, specify answer choices at 304 and 306, and specify one or more examples of utterances, with corresponding scores and/or weightings, for each answer choice, in text entry box 304 for example. As an example, assuming the question “Did the agent open the conversation in a clear manner?” is selected in 302, and the answers provided at 304 and 306 are “Yes” and “No” respectively, words/phrases “hello my name is”, “good morning”, “thank you for calling our helpline” can be entered into text box 308 as indications of “Yes” (i.e., a clear opening to the conversation) and words/phrases “what is your problem?”, “yeah”, “and the like can be entered into text box 308 as indications of “No” (i.e., not a clear opening to the conversation).

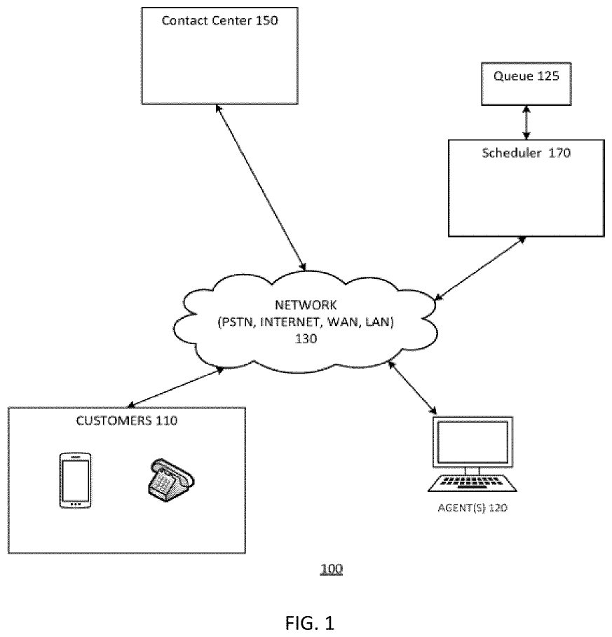

Form templates can be provided with the recommended best practice for sections, questions, and example utterances for each answer choice in order to maximize matching and increase confidence level. Customer users (admins) can edit the templates in accordance with their business needs. Additionally, users can specify a default answer choice which will be selected if none of the example utterances were detected with high confidence. In the example above, “no greeting given” might be a default answer choice, with 0 points, if a greeting is not detected. When an AI evaluation form created through UI 300 is saved, the example utterances are used to train AI model 232 (FIG. 1) with an intent for every question choice. In the example above, AI model 232 might have 8 intents: good greeting, poor greeting, good problem solving, poor problem solving, good empathy, poor empathy, good closing, poor closing, for example.

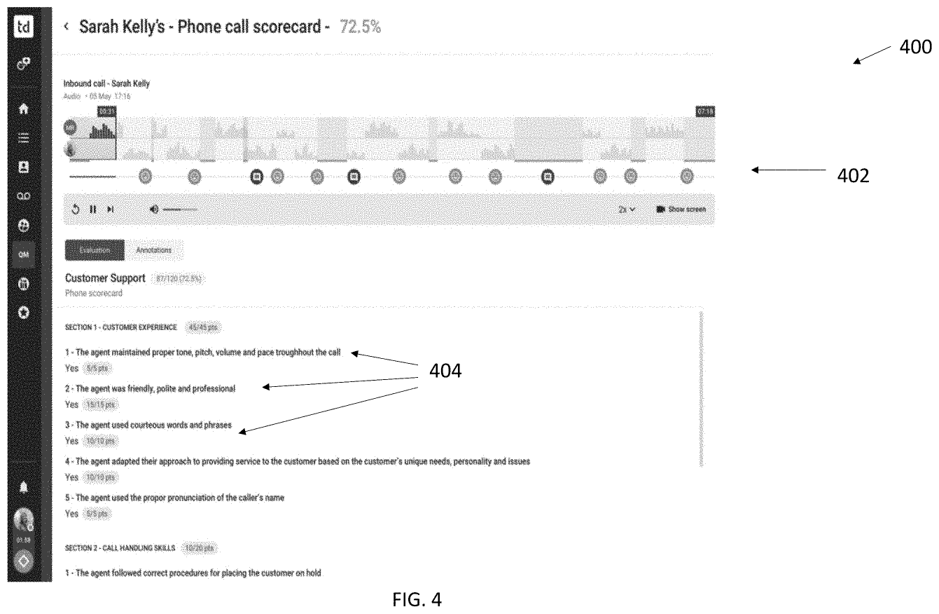

When a voice interaction is completed, an audio recording of the interaction, created by recording module 222 (FIG. 2) can be sent to a speech transcription engine of transcription module 224 (FIG. 2) and the resulting transcription is stored in a digital file store. When the transcription is available, a message can be sent and the transcription can be processed by an intent detection engine on intent module 234 (FIG. 2). Utterances in the transcription can be enriched via intent detection by intent module 234. An annotation, such as one or more tags, can be associated with the interaction as shown in FIG. 4 which illustrates user interface 400 and the positive or negative choices detected in the interaction being processed based on the questions in the evaluation form created with user interface 300 of FIG. 3. As shown at 402, annotations can be associated with portions of the interaction to indicate detected intent during that portion of the interaction. For example, the annotations can be green happy faces (for positive intent), red happy faces (for negative intent), and grey speech bubbles (where there wasn't a high confidence based on the automated analysis). The corresponding positive or negative choices for the interaction, as evaluated by the AI model 232, and the corresponding questions, are indicated at 404. The tags can indicate intent, the question and choice associated with that intent, and whether that choice was positive, negative, or low confidence.

Based on the positive or negative choices, a new evaluation of the corresponding interaction will be generated for the agent, by assessment module 230 of FIG. 1, with a score. For example, the score can be based on a percentage of the points achieved from the detected choices with respect to the total possible score. If both positive and negative problem solving examples are detected, then the question can be assigned as the negative option (i.e., the one worth fewer points), for example, as it might be desirable for the system to err on the side of caution and detection of potential issues. As an alternative, disclosed implementations might look for a question option that has a medium number of points and use that as the point score for the utterances. Based on these positive and negative annotations detected automatically by assessment module 230, the corresponding rating will be calculated on the evaluation form itself for that particular section. If for some questions, no intent is found with a high confidence, the default answer voice can be selected. If for some questions, intents are found, but a low confidence level, those low confidence matches will be annotated and the form can be presented to users as pending for manual review.

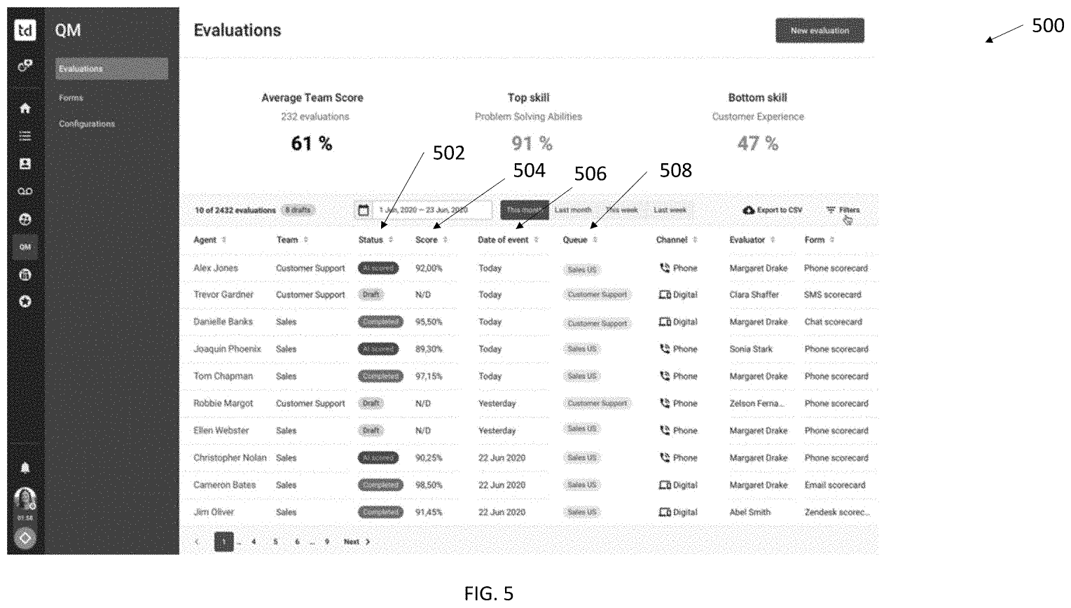

Evaluations accomplished automatically by assessment module 230 are presented to the user on an evaluations page user UI 500 or results module 250 as shown in FIG. 5. Each evaluation can be tagged as “AI Scored”, “AI Pending”, “Draft” or “Completed” , in column 502, to differentiate them from forms that were manually “Completed” by an evaluator employee. In this example, Draft means the evaluation was partially filled in by a person, AI Pending means the evaluation was partially filled in by the AI but there were some answers with low confidence, AI Scored means the evaluation was completely filled in by the AI, and Completed means the evaluation was completely filled in by a person or reviewed and updated by a person after it was AI Pending or AI Scored.

Of course, other relevant data, such as Score (column 504), date of the interaction (column 506), queue associated with the interaction (column 508), and the like can be presented on evaluations page UI 500. Additionally, the average score, top skill, and bottom skill widgets (all results of calculations by assessment module 230 or results module 250) at the top of UI 500 could be based on taking the AI evaluations into account at a relatively low weighting (only 10% for example) as computer to forms completed manually by an evaluator employee. This weight may be configurable by the user.

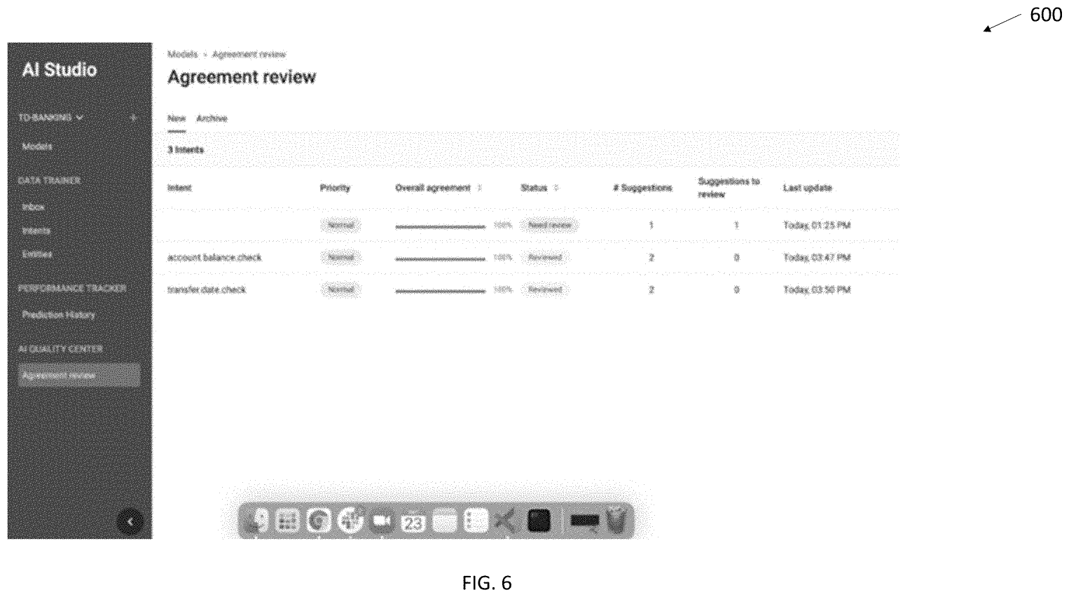

When an AI form cannot be evaluated automatically and scored completely by the system (e.g., the intent/answer cannot be determined on one or more particular questions), then these evaluations will show in an AI Pending state in column 504 of FIG. 5 and can be designated to require manual intervention/review/correction to move to a Completed status. Users can review these AI Pending evaluations and update the question responses selected on them. Doing this converts the evaluation to the “Completed” state where they are given the full weight (same as the ones completed manually from the start). Users can also choose to review and update the AI Scored evaluation, but this is an optional step which would only occur if, for example, a correction was needed. Updates that the employee evaluator made can be sent to a corrections API of AI model 232. The corrections can be viewed on a user interface, e.g. , a UI similar to UI 300 of FIG. 3, and a non AI expert, such as a contact center agent or administrator, can view the models and corrections and can choose to add the example utterance to the intent that should have been selected, or to ignore the correction. If multiple trainers all agree to add an utterance, the new training set will be tested against past responses in an Agreements Review page of the UI 600 shown in FIG. 6, and, if the AI model identifies all of them correctly, an updated model will be published and used for further analysis. As a result of this process, the training set grows and the AI model improves over time.

The UI can provide a single view into corrections from multiple systems that use intent detection enrichment. For example, incorrect classifications from a virtual agent or knowledge base search could also be reviewed on the UI. Real-time alerts can be provided based on real-time transcription and intent detection to notify a user immediately if an important question is being evaluated poorly by AI model 232. Emotion/crosstalk/silence checks can be added to the question choices on the forms in addition to example utterances. For example, for the AI model to detect Yes, it might have to both match the Yes intent via the example utterances and have a positive emotion based on word choice and tone.

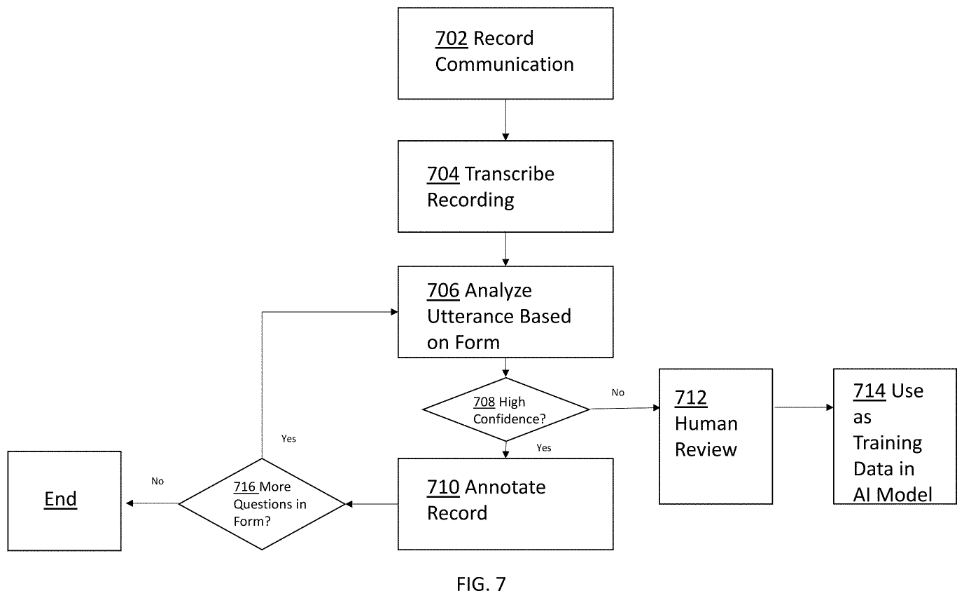

FIG. 7 illustrates a method in accordance with disclosed implementations. At 702, a call center communication, such as a phone call is recorded (by recording module 22 of FIG. 3, for example). At 704, the recording is transcribed into digital format using known transcription techniques (by transcription module 224 of FIG. 2, for example). At 706, each utterance is analyzed by an AI model (such as AI model 232 of FIG. 2) based on the appropriate form to determine intent and a corresponding confidence level of the determined intent for a question on the form. At 708, if intent is detected with a high confidence (based on a threshold intent score for example), then the intent is annotated in a record associated with the communication at 710. If the intent is found with a low confidence, the intent determination is marked for human review at 712 and the results of the human review are sent back to the AI model as training data at 714. As noted above, the human review can include review by multiple persons and aggregating the responses of the multiple persons. Steps 706, 708 and 710 (and 712 and 714 when appropriate) are repeated for each question in the form based on the determination made at 716.

The elements of the disclosed implementations can include computing devices including hardware processors and memories storing executable instructions to cause the processor to carry out the disclosed functionality. Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like. Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The computing devices can include a variety of tangible computer readable media. Computer readable media can be any available tangible media that can be accessed by device and includes both volatile and non-volatile media, removable and non-removable media. Tangible, non-transient computer storage media include volatile and non-volatile, and removable and non-removable media implemented in any method or technology for storage of information such as computer readable instructions, data structures, program modules or other data.

The various data and code can be stored in electronic storage devices which may comprise non-transitory storage media that electronically stores information. The electronic storage media of the electronic storage may include one or both of system storage that is provided integrally (i.e., substantially non-removable) with the computing devices and/or removable storage that is removably connectable to the computing devices via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media.

Processor(s) of the computing devices may be configured to provide information processing capabilities and may include one or more of a digital processor, an analog processor, a digital circuit designed to process information, an analog circuit designed to process information, a state machine, and/or other mechanisms for electronically processing information. As used herein, the term “module” may refer to any component or set of components that perform the functionality attributed to the module. This may include one or more physical processors during execution of processor readable instructions, the processor readable instructions, circuitry, hardware, storage media, or any other components.

The contact center 150 of FIG. 1 can be in a single location or may be cloud-based and distributed over a plurality of locations, i.e. a distributed computing system. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed:

1. A method for assessing communications between a user and an agent in a call center, the method comprising:
extracting text from a plurality of communications between a call center user and a call center agent to thereby create a communication record;
for each of the plurality of communications:
assessing the corresponding text of a communication record by applying an AI assessment model to obtain an intent assessment of one or more aspects of the communication, wherein the AI assessment model is developed by processing a set of initial training data and supplemental training data to detect intents.

2. The method of claim 1, wherein the intent assessment includes a confidence score of the communication and further comprising flagging the communication record for manual quality management analysis and annotation if a confidence score of the intent assessment is below a threshold value.

3. The method of claim 2, wherein the intent assessment comprises multiple fields, each field having a value selected from a corresponding set of values and wherein the confidence level is based on a confidence sub-level determined for each value of each field.

4. The method of claim 3, wherein the fields and corresponding sets of values correspond to a human-readable form used for the manual annotation.

5. The method of claim 1, wherein the AI assessment model considers acceptable key words or phrases in each of a plurality of categories and the annotations include key words or phrases that are to be added to a category as acceptable.

6. The method of claim 1 where supplemental training data is added to the model based on reviewing manual corrections to previous assessments by the assessment model

7. The method of claim 6, wherein the supplemental data is based on manual quality analysis by a plurality of people and determining consensus between the people.

8. A computer system for assessing communications between a user and an agent in a call center, the system comprising:
at least one computer hardware processor; and
at least one memory device operatively coupled to the at least one computer hardware processor and having instructions stored thereon which, when executed by the at least one computer hardware processor, cause the at least one computer hardware processor to carry out the method of:
extracting text from a plurality of communications between a call center user and a call center agent to thereby create a communication record;
for each of the plurality of communications:
assessing the intent of corresponding text by applying an AI assessment model to obtain an intent assessment of the communication, wherein the AI assessment model is developed by processing a set of initial training data to detect intents.

9. The system of claim 8, wherein the intent assessment includes a confidence score of the communication and further comprising flagging the communication record for manual quality management analysis and annotation if a confidence level of the assessment is below a threshold score.

10. The system of claim 9, wherein each intent assessment comprises multiple fields, each field having a value selected from a corresponding set of values and wherein the confidence level is based on a confidence sub-level determined for each value of each field.

11. The system of claim 10, wherein the fields and corresponding sets of values correspond to a human-readable form used for the manual annotation.

12. The system of claim 8, wherein the AI assessment model considers acceptable key words or phrases in each of a plurality of categories and the annotations include key words or phrases that are to be added to a category as acceptable.

13. The system of claim 8 where supplemental training data is added to the model based on reviewing manual corrections to previous assessments by the assessment model

14. The system of claim 8, wherein the supplemental data is based on manual quality analysis by a plurality of people and determining consensus between the people.

15. A method for assessing communications a contact center interaction, the method comprising:
receiving communication records relating to an interaction in a contact center, wherein each communication record includes text strings extracted from the corresponding communication and wherein each call record has been designated by an AI assessment model trained to accomplish an assessment of one or more aspects of the communication records, wherein the AI assessment model is developed by processing a set of initial training data;
for each communication record:
displaying at least one of the text strings on a user interface in correspondence with at least one ai assessment;
receiving, from a user, an assessment of the at least one text strings relating to the AI assessment;
updating the communication record based on the assessment to create an updated communication record; and
applying the updated communication record to the AI assessment model as supplemental training data.

16. The method of claim 15, wherein the supplemental data is based on manual quality analysis by a plurality of people and determining consensus between the people.
